(19) United States
(12) Patent Application Publication
(10) Pub. No.: US 2025/0231306 A1
(43) Pub. Date: Jul. 17, 2025

(54) GENERATING A VELOCITY MODEL FOR A SUBSURFACE STRUCTURE USING A MACHINE LEARNING MODEL

(71) Applicant: Saudi Arabian Oil Company, Dhahran (SA)

(72) Inventor: Yousuf Fadol Alkarem, Dhahran (SA)

(21) Appl. No.: 18/415,280

(22) Filed: Jan. 17, 2024

(51) Int. Cl. G01V 1/28; G01V 1/30; G01V 1/50

(52) U.S. Cl. CPC G01V 1/282; G01V 1/303; G01V 1/50; G01V 2210/6222; G01V 2210/65

(57) ABSTRACT

Among other things, techniques are described for generating a velocity model for a subsurface structure using a machine learning model. A method can include generating, using seismic data and sonic log data from a subterranean surface, one or more Time-to-Depth Relationship (TDR) curves; generating, using (i) the seismic data and sonic log data and (ii) the one or more TDR curves, a combined set of seismic data and sonic log data; selecting one or more seismic reflectors; generating, using the one or more seismic reflectors, a velocity model update; generating, using the velocity model update and one or more operations of pre-stack depth migration, a candidate final velocity model; determining the candidate final velocity model satisfies a matching threshold; and in response, providing the final velocity model as output.

### TECHNICAL FIELD

This disclosure relates to exploration and production of hydrocarbons, and more specifically, to generating a velocity model for a subsurface structure using a machine learning model.

### BACKGROUND

In a geophysics analysis, a velocity model is an important factor in understanding the subsurface structure of a region. In a subsurface region, sedimentary rock forms through deposition over time. Layers of rock are created from different materials under varying conditions. Therefore, each layer of rock has different properties. A velocity model maps out the layers of rock in a monitoring region and the speed seismic waves travel in each layer. A velocity model can be used to interpret seismic signals observed in the monitoring region and to generate images of the subsurface area. Therefore, a good velocity model can provide better understanding of the subsurface structure and improve the efficiency of a hydrocarbon exploration or production operation in the geographic area.

### SUMMARY

Techniques described in this document relate to combining sonic logs and seismic data to help identify seismic reflectors used in generating a velocity model for pre-stack depth migration (PSDM). A machine learning model can be trained to identify seismic reflectors using, at least in part, user selection data of seismic reflectors. The trained model can select seismic reflectors in cases where no sonic data is available.

One computer-implemented method includes generating, using seismic data and sonic log data from a subterranean surface, one or more Time-to-Depth Relationship (TDR) curves; generating, using (i) the seismic data and sonic log data and (ii) the one or more TDR curves, a combined set of seismic data and sonic log data; selecting, using: (a) one or more of (i) a selector engine or (ii) machine learning model selector, and (b) the combined set of seismic data and sonic log data, one or more seismic reflectors; generating, using the one or more seismic reflectors, a velocity model update; generating, using the velocity model update and one or more operations of pre-stack depth migration, a candidate final velocity model; determining the candidate final velocity model satisfies a matching threshold; and in response to determining the candidate final velocity model satisfies the matching threshold, providing the final velocity model as output.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware, installed on the system that in operation causes the system to perform the actions. One or more computer programs can be configured to perform particular operations or actions by virtue of including instructions that when executed by data processing apparatus cause the apparatus to perform the actions.

The foregoing and other implementations can each, optionally, include one or more of the following features, alone or in combination:

A first aspect, combinable with the general implementation, where selecting the one or more seismic reflectors includes selecting, using an indication of one or more velocity knees included in the combined set of seismic data and sonic log data, the one or more seismic reflectors.

A second aspect, combinable with any of the previous aspects, where the machine learning model selector includes one or more Convolutional Neural Networks (CNN).

A third aspect, combinable with any of the previous aspects, where, prior to generating the combined set of seismic data and sonic log data, actions include: generating, using (i) the seismic data and sonic log data and (ii) the one or more TDR curves, an initial combined set of seismic data and sonic log data; selecting, using: (a) one or more of (i) the selector engine or (ii) the machine learning model selector, and (b) the initial combined set of seismic data and sonic log data, one or more initial seismic reflectors; generating, using the one or more initial seismic reflectors, an initial velocity model update; generating, using the initial velocity model update and one or more operations of pre-stack depth migration, an initial candidate final velocity model; determining the initial candidate final velocity model does not satisfy the matching threshold; and in response to determining the initial candidate final velocity model does not satisfy the matching threshold, generating, using (i) the seismic data and sonic log data and (ii) the one or more TDR curves, the combined set of seismic data and sonic log data.

A fourth aspect, combinable with any of the previous aspects, where determining the candidate final velocity model satisfies the matching threshold includes: determining whether a portion of enhanced seismic data of the candidate final velocity model matches a portion of drilled wells data or seismograms.

A fifth aspect, combinable with any of the previous aspects, where determining whether the portion of enhanced seismic data of the candidate final velocity model matches the portion of drilled wells data or seismograms includes: determining whether a depth value of the portion of enhanced seismic data of the candidate final velocity model matches a depth value of the portion of drilled wells data or seismograms.

A sixth aspect, combinable with any of the previous aspects, including providing a user interface for selecting the one or more seismic reflectors using the combined set of seismic data and sonic log data.

A seventh aspect, combinable with any of the previous aspects, including determining well placement using the final velocity model.

An eighth aspect, combinable with any of the previous aspects, including determining drill path planning using the final velocity model.

A ninth aspect, combinable with any of the previous aspects, including determining a subsurface structure using the final velocity model.

Another computer-implemented method includes generating, using obtained seismic data and sonic log data, one or more Time-to-Depth Relationship (TDR) curves; generating, using (i) the seismic data and sonic log data and (ii) the one or more TDR curves, a combined set of seismic data and sonic log data; selecting, using a selector engine and the combined set of seismic data and sonic log data, one or more seismic reflectors; providing the combined set of seismic data and sonic log data to a machine learning model selector; in response to providing the combined set of seismic data and sonic log data to the machine learning model selector, generating an output result from the machine learning model selector; comparing the one or more seismic reflectors and the output result from the machine learning model selector; and updating, using the comparison of the one or more seismic reflectors and the output result from the machine learning model selector, the machine learning model selector.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware, installed on the system that in operation causes the system to perform the actions. One or more computer programs can be configured to perform particular operations or actions by virtue of including instructions that when executed by data processing apparatus cause the apparatus to perform the actions.

Particular implementations of the subject matter described in this specification can be implemented in order to improve accuracy of assigned depth values to the interpreted horizons used in building a velocity model. Techniques can include robust velocity model building that enhances seismic imaging and increases precision in depth positioning of seismic reflectors. Techniques can enable more accurate characterization of subsurface structure and target reservoir distributions.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the following description. Other features and advantages of the disclosure will be apparent from the description and drawings, and from the claims.

### BRIEF DESCRIPTION OF THE DRAWINGS

FIG. 1 shows a system implementing a process for generating an improved velocity model using sonic logs and a machine learning network.

FIG. 2 shows a collection of seismic cross sections.

FIG. 3 shows a second collection of seismic cross sections.

FIG. 4 illustrates a flowchart of an example method, according to some implementations.

FIG. 5 illustrates a flowchart of an example method 500, according to some implementations.

FIG. 6 illustrates some example hydrocarbon production operations.

FIG. 7 is a block diagram of an example computer system, according to some implementations.

### DETAILED DESCRIPTION

This disclosure generally describes methods and systems, including computer-implemented methods, computer program products, and computer systems, for generating improved velocity models for use in seismic migration techniques, such as Seismic Pre-stack Depth Migration (PSDM). The following description is presented to enable any person skilled in the art to make and use the disclosed subject matter, and is provided in the context of one or more particular implementations. Various modifications to the disclosed implementations will be readily apparent to those skilled in the art, and the general principles defined in this disclosure may be applied to other implementations and applications without departing from scope of the disclosure. Thus, the present disclosure is not intended to be limited to the described or illustrated implementations, but is to be accorded the widest scope consistent with the principles and features described in this disclosure.

Seismic PSDM is a migration method for high resolution imaging of seismic data acquired either from earth's surface or within single or multiple drilled well locations. PSDM involves repositioning seismic reflection data into their correct spatial locations in the subsurface, creating a more accurate image of the geological structures. One of the inputs for performing seismic PSDM includes an initial velocity model that is built using interpreted seismic horizons, e.g., with horizon depth values at drilled well locations.

The PSDM process includes several iterations of seismic data migration and velocity inversion. The velocity model is modified after each iteration until a final velocity model is generated. In existing techniques, however, assigning inaccurate depth values to the interpreted horizons at the drilled well locations and selecting unsuitable seismic reflectors to be interpreted for velocity model building at each stage is a common occurrence.

In some cases, interpreters—e.g., operators using one or more interfaces to make selections for interpreted horizons—try to provide interpreted horizons for as many seismic events as possible. Interpreted horizons generated by interpreters might include multiples or seismic events that cannot be easily or accurately traced throughout a seismic volume. Also, some of these horizons, if not most of them, can be associated with a nearest conventionally picked well tops that do not necessarily have the same depth values of the correct corresponding velocity knee since conventional well tops are picked based on other criteria that are different from formation velocities. Incorrect interpreted horizons can be one of the root causes of discrepancies between seismic images and well data (e.g., misties observed on PSDM seismic data with the well data). Associating interpreted horizons with a wrong well top can degrade seismic data migration and imaging.

This disclosure describes systems and methods for optimized velocity model building and seismic PSDM migration and imaging. Among other things, the disclosed systems and methods resolve the common error of assigning inaccurate depth values to the interpreted horizons at the drilled well locations and facilitate the selection of appropriate seismic reflectors to be interpreted for velocity model building, e.g., at each stage in the seismic PSDM process. As described below, the techniques have resulted in improved PSDM seismic data that is accurately integrated to the wells in the depth domain.

In some implementations, techniques include building an initial velocity model for PSDM. Building a velocity model can begin with determining one or more interpreted horizons of seismic reflectors, e.g., that are clear and can be traced and mapped throughout a seismic volume. Rather than providing interpretations of as many seismic events as possible, which can be time-consuming and may include non-primary seismic events, the interpreted horizons can be restricted to reflectors that are associated with high velocity contrasts.

The depth values of the interpreted horizons at the drilled well locations can be used for building the velocity model. For robust velocity model building, important seismic reflectors to be interpreted include those that are associated with sharp velocity contrasts. The drilled well depth values of these sharp velocity contrasts—otherwise referred to as velocity knees—can be used in building a velocity model. The velocity knee well markers that correspond to the provided horizons can be selected—e.g., using an automatic process or using a trained selector—from the drilled wells sonic logs because the horizons show sharp velocity contrasts. Using velocity knee well markers can help ensure higher accuracy for determining depth values than using conventional well tops which may not necessarily correspond to an interpreted horizon. For wells that do not have sonic logs but have other types of logs, pseudo sonic logs can be generated using the other types of logs so that velocity knees can be picked at these wells. In some implementations, applications for generating pseudo sonic logs can be used, e.g., Techlog.

In some implementations, machine learning is used to improve accuracy or efficiency of velocity knee selection. For example, artificial intelligence-based well correlation for picking the velocity knees can expedite the process especially when there is a large number of wells. The

PSDM process can include several iterations of seismic data migration and velocity inversion. After each PSDM processing iteration, interpreted horizons of other enhanced seismic reflectors along with their velocity knee depth values can be added to the modified velocity model until a final velocity model is reached. The techniques described in this document help to build velocity models for improved depth imaging with more accurate seismic-to-well tie in the depth domain.

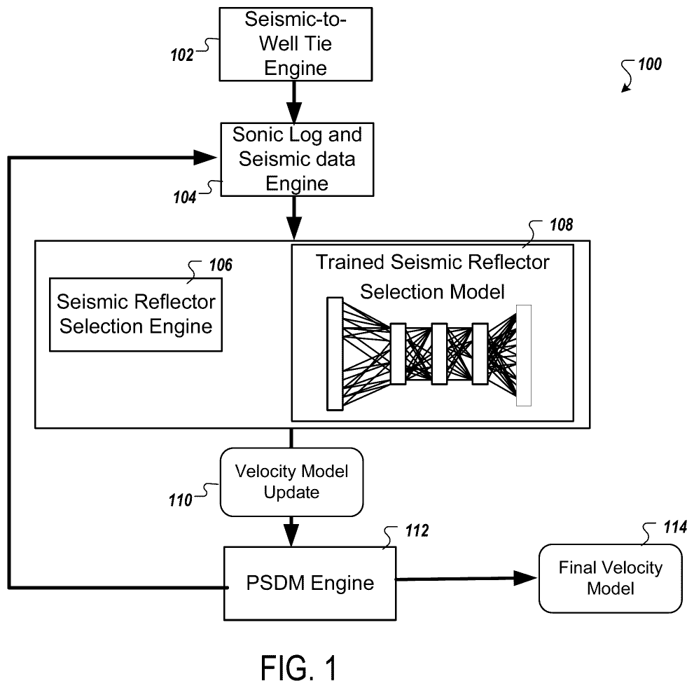

FIG. 1 shows a system 100 implementing a process for generating an improved velocity model using sonic logs and a machine learning network. The system 100 can include one or more computers to perform one or more processes shown in FIG. 1 or discussed in this document. The system 100 includes a seismic-to-well tie engine 102, a sonic log and seismic data engine 104, a seismic reflector selection engine 106, a trained seismic reflector selection model 108, and a PSDM engine 112.

In general, FIG. 1 shows a combination of sonic logs with seismic data to help identify velocity knees used to generate a velocity model for pre-stack depth migration (PSDM). An AI model—e.g., the trained seismic reflector selection model 108—can be trained to identify velocity knees using, at least in part, user selection data of velocity knees. The AI model, after training, can select velocity knees, e.g., in cases where no sonic data is available.

The trained seismic reflector selection model 108 can be trained to help generate an improved velocity model to be used in related processes—e.g., pre-stack depth migration (PSDM). Velocity knees can be selected, e.g., where there is sonic data. Then a pretrained version of the model 108 can be trained using the velocity knee selections. The model 108 can generate selections for additional velocity knees—e.g., in areas without available sonic data. In some implementations, a combination of seismic data and sonic logs for identifying velocity knees can be used to help improve model generation.

The seismic-to-well tie engine 102 processes one or more items of seismic data—e.g., seismic data of one or more well locations. In some implementations, the seismic-to-well tie engine 102 generates Time-to-Depth Relationship (TDR) curves. The TDR curves can be used to allow seismic data to be viewed with sonic data. Because seismic data is typically acquired in time domain and sonic logs are typically acquired in depth domain, the seismic-to-well tie engine 102 can generate one or more TDR curves to convert between time and depth. In some cases, the seismic-to-well tie engine 102 can include a seismic interpretation application, such as PETREL.

The sonic log and seismic data engine 104 processes one or more portions of seismic or sonic data. For example, the sonic log and seismic data engine 104 can combine one or more sonic logs with one or more items of seismic data to generate a combined sonic and seismic data set—e.g., using one or more TDR curves generated by the seismic-to-well tie engine 102. The sonic log and seismic data engine 104 can provide the combined sonic and seismic data set to the seismic reflector selection engine 106 and the trained seismic reflector selection model 108.

The seismic reflector selection engine 106 and the trained seismic reflector selection model 108 can select one or more seismic reflectors to help generate a velocity model update 110. In some implementations, the seismic reflector selection engine 106 includes one or more algorithmic processes for seismic reflector selection. In some implementations, the seismic reflector selection engine 106 includes one or more interfaces for human provided ground truth data. For example, training can include using human provided ground truth from the seismic reflector selection engine 106. By tying wells to seismic data (e.g., seismic-to-well tie engine 102) and generating a combined view of sonic logs on seismic data (e.g., sonic log and seismic data engine 104), manual selection can be improved. In some cases, the seismic reflector selection engine 106 can include trained human operators that select velocity knees shown as sharp contrasts on sonic logs or clear reflectors on seismic data. Several velocity knees can be selected for each well.

The trained seismic reflector selection model 108 can include one or more fully connected, or partially connected, layers. The trained seismic reflector selection model 108 can include one or more types of machine learning model, e.g., convolutional neural networks (CNN).

In some cases, the trained seismic reflector selection model 108 can be trained by manually selecting—e.g., by the seismic reflector selection engine 106—velocity knees for one or more wells. The manual selection of velocity knees can be used as ground truth data for training a pretrained version of the trained seismic reflector selection model 108. During operation, the trained seismic reflector selection model 108 can generate all or some of the selections. For example, the trained seismic reflector selection model 108 can be combined with one or more manual selections or generate all selections without any manual selections. In some implementations, iterations of automatic selection with the trained seismic reflector selection model 108 where the selections are checked against manual selections for accuracy, can be performed to determine an accuracy of the trained seismic reflector selection model 108. When the accuracy of the trained seismic reflector selection model 108 satisfies an accuracy threshold, the trained seismic reflector selection model 108 can be used to generate all or some of the selections used to generate the velocity model update 110.

The PSDM engine 112 can obtain the velocity model update 110, e.g., from the seismic reflector selection engine 106 or the trained seismic reflector selection model 108. The PSDM engine 112 can use the velocity model update 110 to conduct seismic pre-stack depth migration and reflection tomography, e.g., to refine the velocity model and seismic imaging. The PSDM engine 112 can perform iterations by providing updated values to the sonic log and seismic data engine 104. For example, after each iteration, one or more interpreted horizons of enhanced seismic reflectors along with their velocity knee depth values can be added to the velocity model until a final velocity model 114 is generated—e.g., the final velocity model can include one or more seismic images. The PSDM engine 112 or other component of the system 100 can determine if the enhanced seismic data shows a good tie with the drilled wells data or seismograms in the depth domain—e.g., if the enhanced seismic data and the drilled wells data or seismograms in the depth domain match each other where a matching amount satisfies a matching threshold. A correlation coefficient threshold, such as 0.7, a higher value, or other value, between the seismic and well data can be considered to show a good tie.

The system 100 can help restrict interpreted horizons to reflectors that are associated with high velocity contrasts. The velocity knee well markers that correspond to provided horizons can be selected from drilled wells sonic logs because the sonic logs can show sharp velocity contrasts. Using velocity knee well markers can help ensure higher accuracy for determining depth values compared to using conventional well tops. The response of the velocity knees on other types of well logs can be defined so that the velocity knees can be picked at the drilled wells that do not have sonic logs but have other types of well logs. AI-based well correlation for picking the velocity knees—e.g., the trained seismic reflector selection model 108—can expedite the process especially when there is a large number of wells. The system 100 can help perform one or more iterations of PSDM inverting seismic data migration and velocity. After each PSDM processing iteration, more interpreted horizons of other enhanced seismic reflectors along with their velocity knee depth values can be added to the modified velocity model—e.g., the velocity model update 110—until the final velocity model 114 is generated.

In some implementations, the system 100 can include one or more interfaces that direct users—e.g., human operators—to obtain depth values of interpreted horizons for depth imaging using drilled wells and sonic logs. Existing methods, e.g., using conventional well tops, do not necessarily have the same depth values of the correct velocity knees corresponding to the provided horizons. The processes illustrated and described in reference to FIG. 1 and included in this document help to improve accuracy of the selected reflectors for generating the final velocity model 114. The techniques can also reduce processing time by reduce time previously required for adding selected reflectors in multiple iterations.

The techniques described in this document, including those shown in FIG. 1, can solve for the mistake of assigning inaccurate depth values to interpreted horizons at drilled well locations. The techniques incorporate artificial intelligence to reduce processing time and to facilitate selection of accurate seismic reflectors to be interpreted for velocity model building at different processing stages. By helping to ensure that the seismic horizon interpretations are associated and tied with the correct drilled wells velocity knee depth values, the described techniques can help generate robust velocity models and seismic data migration and imaging.

In some implementations, the techniques described, e.g., in reference to FIG. 1, can be performed in software. For example, the software can guide users with different levels and types of experience to follow steps in an automated or self-descriptive way. The software can include visual indicators that prompt users to, e.g., select one or more seismic reflectors or load one or more items of data for processing by one or more engines shown and discussed in reference to FIG. 1.

In some implementations, the final velocity model 114 can be used by seismic data processors or interpreters, e.g., in industries that utilize subsurface seismic imaging such as the industries of Oil & Gas, Geothermal Energy, Mining, Archeology, Civil Engineering & Infrastructure, or Environmental studies.

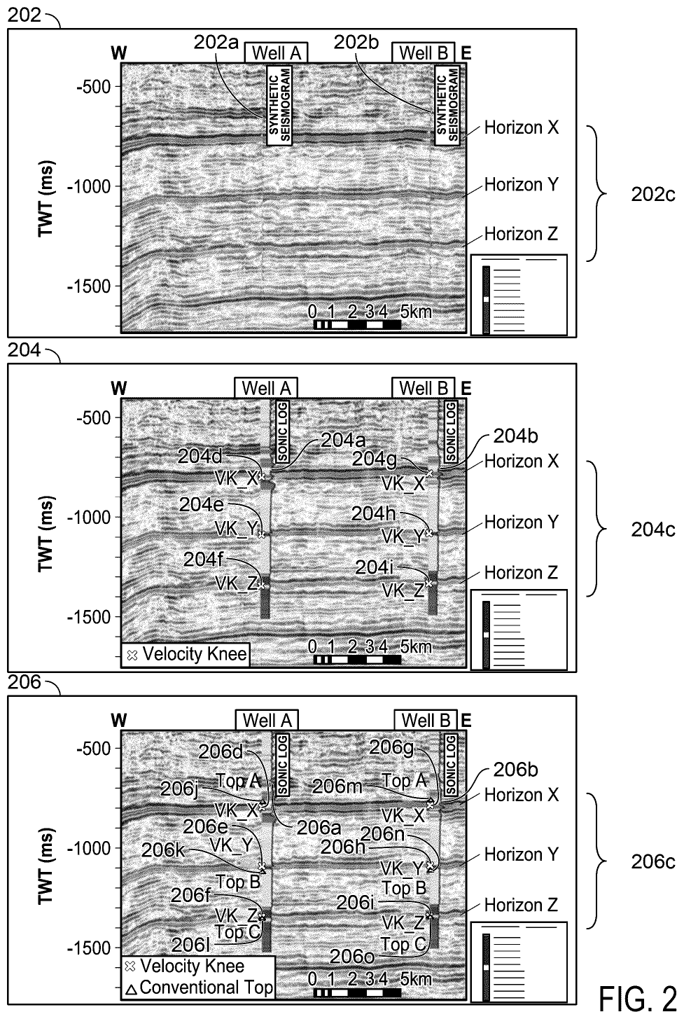

FIG. 2 shows a collection of seismic cross sections in reference to techniques described in this document. Item 202 shows a seismic cross section with drilled wells synthetic seismograms (202a and 202b) and interpreted seismic events (202c) for building a velocity model. Item 204 shows a seismic cross section with drilled wells sonic logs (204a and 204b), interpreted seismic events (204c) and corresponding velocity knees (204d-i). The interpreted horizons (204c) can be associated with one or more depth values of corresponding velocity knees for building a velocity model. Item 206 shows a seismic cross section with drilled well sonic logs (206a and 206b), interpreted seismic events (206c), corresponding velocity knees (206d-i) and conventional tops (206j-o) which are selected based on other criteria different from formation velocities. In existing techniques, users use conventional well tops which would not typically correspond to interpreted horizons—e.g., there is a difference between the location of the velocity knees (206d-i) and conventional tops (206j-o). The interpreted horizons need to be associated with depth values of corresponding velocity knees for building a velocity model. By generating the interpreted horizons (206c) corresponding to the correct velocity knees (206d-i)—e.g., generated by the system 100 of FIG. 1—the techniques described in this document can improve resulting velocity models.

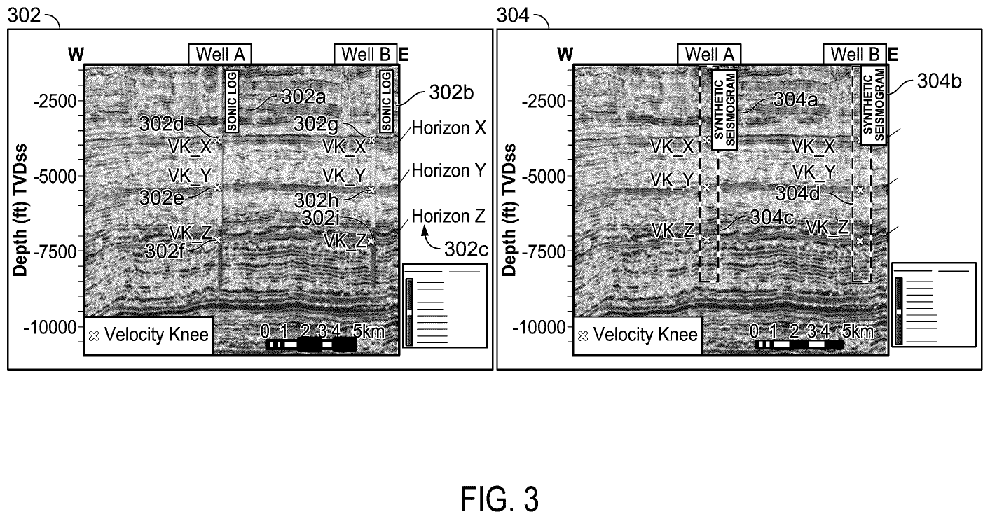

FIG. 3 shows a second collection of seismic cross sections in reference to techniques described in this document—e.g., indicating depth domain after PSDM. Item 302 shows PSDM seismic cross sections in depth domain with drilled well sonic logs (302a-b). Item 304 shows PSDM seismic cross sections in depth domain with drilled well synthetic seismograms (304a-b). The PSDM seismic cross section was produced using interpreted horizons (302c) of strong mappable seismic reflectors along with velocity knee depth values (302d-i) that show sharp velocity contrasts. The resulting PSDM seismic line is well-tied with the drilled wells in the depth domain (items 304c-d).

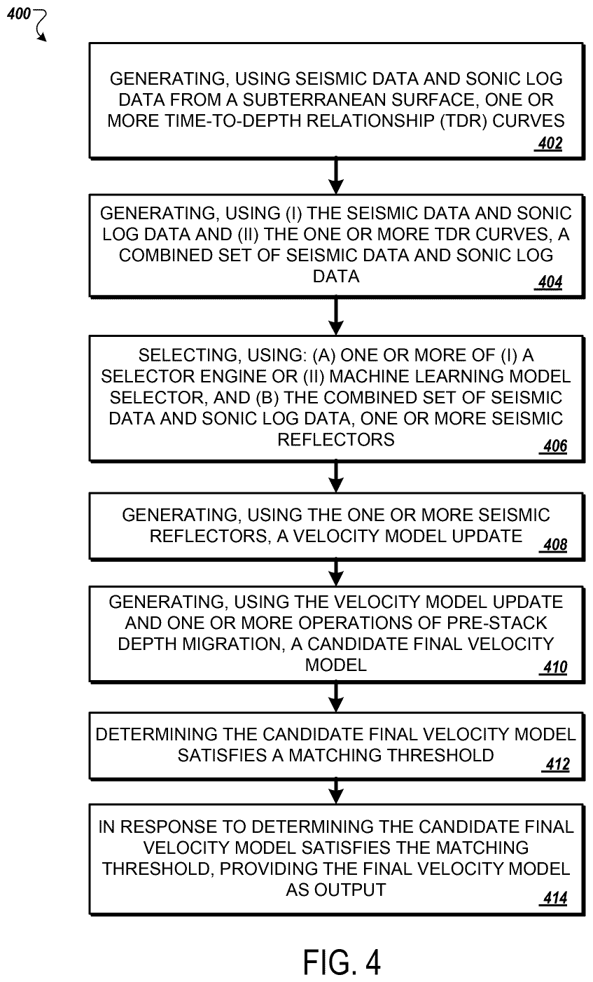

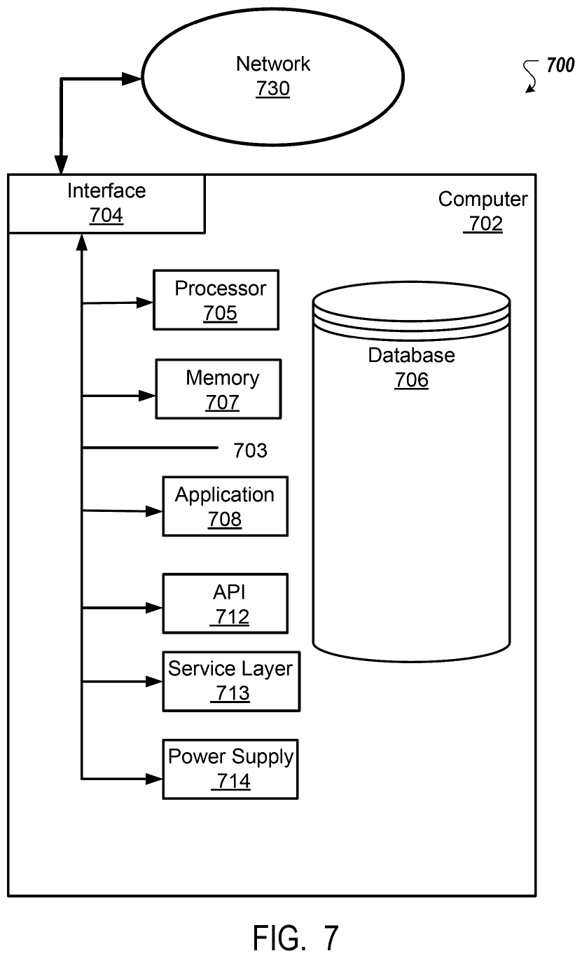

FIG. 4 illustrates a flowchart of an example method 400, according to some implementations. For clarity of presentation, the description that follows generally describes method 400 in the context of the other figures in this description. For example, method 400 can be performed by 700 of FIG. 7. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

The method 400 includes generating, using seismic data and sonic log data from a subterranean surface, one or more Time-to-Depth Relationship (TDR) curves (402). For example, seismic data and sonic log data can be obtained in any applicable manner—e.g., using seismogram technology, sonic impulses, among others. In reference to FIG. 1, the seismic-to-well tie engine 102 can generate one or more TDR curves. The seismic-to-well tie engine 102 can include a seismic interpretation application, such as PETREL.

The method 400 includes generating, using (i) the seismic data and sonic log data and (ii) the one or more TDR curves, a combined set of seismic data and sonic log data (404). For example, the sonic log and seismic data engine 104 can process one or more portions of sonic logs or seismic data to generate a combined sonic and seismic data set.

The method 400 includes selecting, using: (a) one or more of (i) a selector engine or (ii) machine learning model selector, and (b) the combined set of seismic data and sonic log data, one or more seismic reflectors (406). For example, the seismic reflector selection engine 106 and the trained seismic reflector selection model 108 can select one or more seismic reflectors—e.g., using an indication of one or more velocity knees.

The method 400 includes generating, using the one or more seismic reflectors, a velocity model update (408). For example, the trained seismic reflector selection model 108 can be used to generate all or some of the selections used to generate the velocity model update 110. The seismic reflector selection engine 106 and the trained seismic reflector selection model 108 can help generate the velocity model update 110 by selecting seismic reflectors. In some cases, seismic reflection tomography includes an iterative process for updating and refining a velocity model for depth imaging using grids of selected seismic reflectors.

The method 400 includes generating, using the velocity model update and one or more operations of pre-stack depth migration, a candidate final velocity model (410). For example, the PSDM engine 112 can generate a candidate final velocity model. If the candidate final velocity model satisfies one or more thresholds, the PSDM engine 112 can provide the candidate final velocity model as the final velocity model 114. If the candidate final velocity model does not satisfy one or more thresholds, the PSDM engine 112 can provide an indication for the system 100 to generate one or more updates for a subsequent iteration of seismic reflector selection.

The method 400 includes determining the candidate final velocity model satisfies a matching threshold (412). For example, the PSDM engine 112 determine that a candidate final velocity model satisfies one or more thresholds—e.g., a matching threshold, such as if the enhanced seismic data and the drilled wells data or seismograms in the depth domain match each other.

The method 400 includes in response to determining the candidate final velocity model satisfies the matching threshold, providing the final velocity model as output (414). For example, the PSDM engine 112 of the system 100 can provide the final velocity model 114 to a subsequent process—e.g., for well selection, drill planning, among other processes.

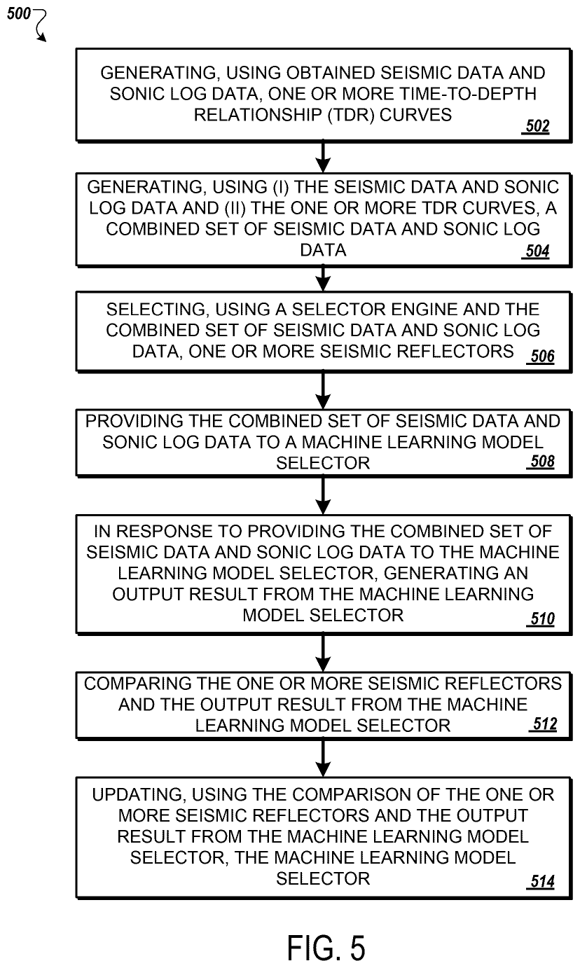

FIG. 5 illustrates a flowchart of an example method 500, according to some implementations. For clarity of presentation, the description that follows generally describes method 500 in the context of the other figures in this description. For example, method 500 can be performed by 700 of FIG. 7. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

The method 500 includes generating, using obtained seismic data and sonic log data, one or more Time-to-Depth Relationship (TDR) curves (502). For example, the seismic-to-well tie engine 102 can be used to generate TDR curves, e.g., using obtained seismic data and sonic log data which can be obtained in any manner suitable.

The method 500 includes generating, using (i) the seismic data and sonic log data and (ii) the one or more TDR curves, a combined set of seismic data and sonic log data (504). For example, the sonic log and seismic data engine 104 can process the seismic data and sonic log data and one or more TDR curves to generate a combined set of seismic data and sonic log data.

The method 500 includes selecting, using a selector engine and the combined set of seismic data and sonic log data, one or more seismic reflectors (506). For example, the seismic reflector selection engine 106 can be used to select one or more seismic reflectors.

The method 500 includes providing the combined set of seismic data and sonic log data to a machine learning model selector (508). For example, an untrained or partially trained version of the trained seismic reflector selection model 108 can be provided, e.g., by the system 100, the combined set of seismic data and sonic log data.

The method 500 includes in response to providing the combined set of seismic data and sonic log data to the machine learning model selector, generating an output result from the machine learning model selector (510). For example, the untrained or partially trained version of the trained seismic reflector selection model 108 can generate an output result based on processing the combined set of seismic data and sonic log data.

The method 500 includes comparing the one or more seismic reflectors and the output result from the machine learning model selector (512). For example, the system 100, or other suitable system, can compare the one or more seismic reflectors selected by the seismic reflector selection engine 106 and the output result from the untrained or partially trained version of the trained seismic reflector selection model 108. Comparing can include generating one or more error values or difference values between one or more portions of the one or more seismic reflectors and the output result.

The method 500 includes updating, using the comparison of the one or more seismic reflectors and the output result from the machine learning model selector, the machine learning model selector (514). For example, the system 100, or other suitable system, can update the untrained or partially trained version of the trained seismic reflector selection model 108 using the one or more error values or difference values between one or more portions of the one or more seismic reflectors and the output result.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

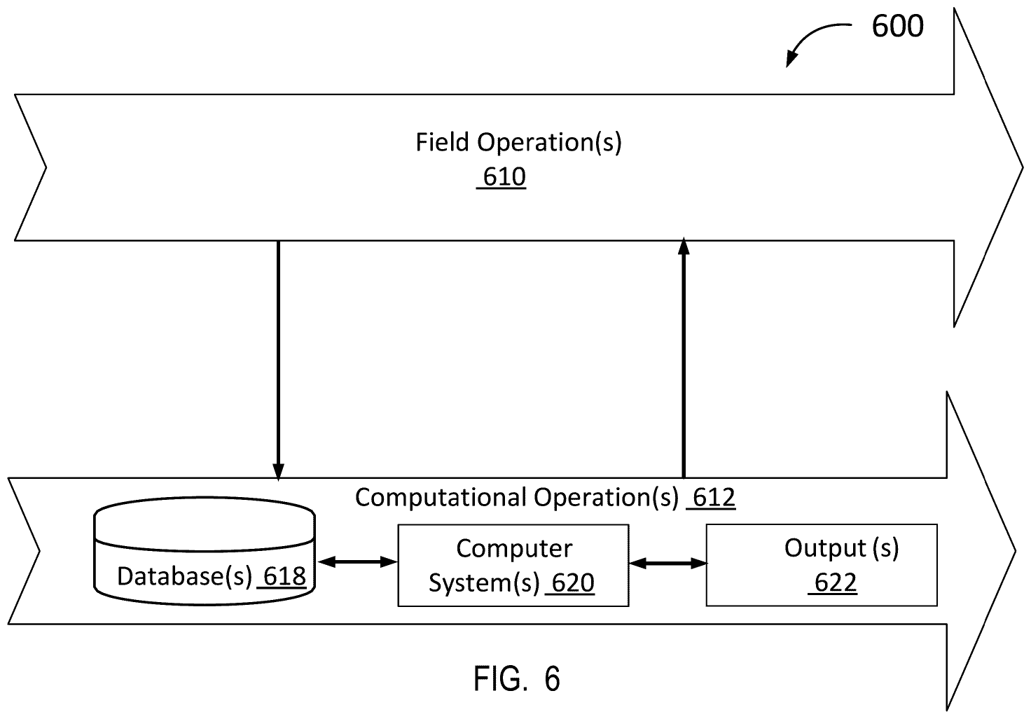

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some cases, seismic signals can be transmitted by a source device. The source device can transmit the seismic signals into the subsurface of the earth at a source location. Examples of the seismic signals include acoustic signals. The seismic signals travel through the subsurface and can be received by a receiver device placed at a receiver location. In some cases, the source device, the receiver device, or a combination thereof can be placed at the surface. The signals can propagate downwards until they reach a reflecting structure and reflect upwards, towards the surface. Because the signals have refracted and reflected through the substructure, the characteristics of the received signals contain information of the substructure. The received signals can be analyzed to produce images of the subsurface structure.

In a marine survey, air guns and hydrophones can be used as the source devices and the receiver devices, respectively. During the acquisition, seismic signals are exploded from arrays of air guns. The reflected and refracted signals are acquired by streamers of hydrophones. In a land acquisition, dynamite can be used as an explosive source and a geophone is employed as a receiver device. In another example, vibratory trucks can be used as source devices. Other devices that generate and receive seismic signals can also be used.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 7 is a block diagram of an example computer system 700 that can be used to provide computational functionalities associated with described algorithms, methods, functions, processes, flows, and procedures, according to some implementations of the present disclosure. In some implementations, the system 100 of FIG. 1 can be the computer system 700, include the computer system 700, or the system 100 can communicate with the computer system 700.

The illustrated computer 702 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 702 can include a Smart Embedded Management Agent (SEMA), such as a built-in ADLINK SEMA 2.2, and a video sync technology, such as Quick Sync Video technology supported by ADLINK MSDK+. In some examples, the computer 702 can include the MXE-5400 Series processor-based fanless embedded computer by ADLINK, though the computer 702 can take other forms or include other components.

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs 712.

The service layer 713 can provide software services to the computer 702 and other components (whether illustrated or not) that are communicably coupled to the computer 702. The functionality of the computer 702 can be accessible for all service consumers using this service layer 713. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 can include an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and manipulate data to perform the operations of the computer 702, including operations using algorithms, methods, functions, processes, flows, and procedures as described in the present disclosure.

The computer 702 can also include a database 706 that can hold data for the computer 702 and other components connected to the network 730 (whether illustrated or not). For example, database 706 can be an in-memory, conventional, or a database storing data consistent with the present disclosure. In some implementations, the database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

An application 708 can be an algorithmic software engine providing functionality according to particular needs, desires, or particular implementations of the computer 702 and the described functionality. For example, an application 708 can serve as one or more components, modules, or applications 708. Multiple applications 708 can be implemented on the computer 702. Each application 708 can be internal or external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system including computer 702, with each computer 702 communicating over network 730. Further, the terms “client,” “user,” and other appropriate terminology can be used interchangeably without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
generating, using seismic data and sonic log data from a subterranean surface, one or more Time-to-Depth Relationship (TDR) curves;
generating, using (i) the seismic data and sonic log data and (ii) the one or more TDR curves, a combined set of seismic data and sonic log data;
selecting, using: (a) one or more of (i) a selector engine or (ii) machine learning model selector, and (b) the combined set of seismic data and sonic log data, one or more seismic reflectors;
generating, using the one or more seismic reflectors, a velocity model update;
generating, using the velocity model update and one or more operations of pre-stack depth migration, a candidate final velocity model;
determining the candidate final velocity model satisfies a matching threshold; and
in response to determining the candidate final velocity model satisfies the matching threshold, providing the final velocity model as output.

2. The method of claim 1, wherein selecting the one or more seismic reflectors comprises:
selecting, using an indication of one or more velocity knees included in the combined set of seismic data and sonic log data, the one or more seismic reflectors.

3. The method of claim 1, wherein the machine learning model selector includes one or more Convolutional Neural Networks (CNN).

4. The method of claim 1, wherein, prior to generating the combined set of seismic data and sonic log data, the method comprises:
generating, using (i) the seismic data and sonic log data and (ii) the one or more TDR curves, an initial combined set of seismic data and sonic log data;
selecting, using: (a) one or more of (i) the selector engine or (ii) the machine learning model selector, and (b) the initial combined set of seismic data and sonic log data, one or more initial seismic reflectors;
generating, using the one or more initial seismic reflectors, an initial velocity model update;
generating, using the initial velocity model update and one or more operations of pre-stack depth migration, an initial candidate final velocity model;
determining the initial candidate final velocity model does not satisfy the matching threshold; and
in response to determining the initial candidate final velocity model does not satisfy the matching threshold, generating, using (i) the seismic data and sonic log data and (ii) the one or more TDR curves, the combined set of seismic data and sonic log data.

5. The method of claim 1, wherein determining the candidate final velocity model satisfies the matching threshold comprises:
determining whether a portion of enhanced seismic data of the candidate final velocity model matches a portion of drilled wells data or seismograms.

6. The method of claim 5, wherein determining whether the portion of enhanced seismic data of the candidate final velocity model matches the portion of drilled wells data or seismograms comprises:
determining whether a depth value of the portion of enhanced seismic data of the candidate final velocity model matches a depth value of the portion of drilled wells data or seismograms.

7. The method of claim 1, comprising:
providing a user interface for selecting the one or more seismic reflectors using the combined set of seismic data and sonic log data.

8. The method of claim 1, comprising:
determining well placement using the final velocity model.

9. The method of claim 1, comprising:
determining drill path planning using the final velocity model.

10. The method of claim 1, comprising:
determining a subsurface structure using the final velocity model.

11. A method for training a machine learning model selector comprising:
generating, using obtained seismic data and sonic log data, one or more Time-to-Depth Relationship (TDR) curves;
generating, using (i) the seismic data and sonic log data and (ii) the one or more TDR curves, a combined set of seismic data and sonic log data;
selecting, using a selector engine and the combined set of seismic data and sonic log data, one or more seismic reflectors;
providing the combined set of seismic data and sonic log data to a machine learning model selector;
in response to providing the combined set of seismic data and sonic log data to the machine learning model selector, generating an output result from the machine learning model selector;
comparing the one or more seismic reflectors and the output result from the machine learning model selector; and
updating, using the comparison of the one or more seismic reflectors and the output result from the machine learning model selector, the machine learning model selector.

12. A non-transitory computer-readable medium storing instructions executable by a computer system to perform operations comprising:
generating, using seismic data and sonic log data from a subterranean surface, one or more Time-to-Depth Relationship (TDR) curves;
generating, using (i) the seismic data and sonic log data and (ii) the one or more TDR curves, a combined set of seismic data and sonic log data;
selecting, using: (a) one or more of (i) a selector engine or (ii) machine learning model selector, and (b) the combined set of seismic data and sonic log data, one or more seismic reflectors;
generating, using the one or more seismic reflectors, a velocity model update;
generating, using the velocity model update and one or more operations of pre-stack depth migration, a candidate final velocity model;
determining the candidate final velocity model satisfies a matching threshold; and
in response to determining the candidate final velocity model satisfies the matching threshold, providing the final velocity model as output.

13. The medium of claim 12, wherein selecting the one or more seismic reflectors comprises:
selecting, using an indication of one or more velocity knees included in the combined set of seismic data and sonic log data, the one or more seismic reflectors.

14. The medium of claim 12, wherein the machine learning model selector includes one or more Convolutional Neural Networks (CNN).

15. The medium of claim 12, wherein, prior to generating the combined set of seismic data and sonic log data, the operations comprise:
generating, using (i) the seismic data and sonic log data and (ii) the one or more TDR curves, an initial combined set of seismic data and sonic log data;
selecting, using: (a) one or more of (i) the selector engine or (ii) the machine learning model selector, and (b) the initial combined set of seismic data and sonic log data, one or more initial seismic reflectors;
generating, using the one or more initial seismic reflectors, an initial velocity model update;
generating, using the initial velocity model update and one or more operations of pre-stack depth migration, an initial candidate final velocity model;
determining the initial candidate final velocity model does not satisfy the matching threshold; and
in response to determining the initial candidate final velocity model does not satisfy the matching threshold, generating, using (i) the seismic data and sonic log data and (ii) the one or more TDR curves, the combined set of seismic data and sonic log data.

16. The medium of claim 12, wherein determining the candidate final velocity model satisfies the matching threshold comprises:
determining whether a portion of enhanced seismic data of the candidate final velocity model matches a portion of drilled wells data or seismograms.

17. The medium of claim 16, wherein determining whether the portion of enhanced seismic data of the candidate final velocity model matches the portion of drilled wells data or seismograms comprises:
determining whether a depth value of the portion of enhanced seismic data of the candidate final velocity model matches a depth value of the portion of drilled wells data or seismograms.

18. The medium of claim 12, comprising:
providing a user interface for selecting the one or more seismic reflectors using the combined set of seismic data and sonic log data.

19. The medium of claim 12, comprising:
determining well placement using the final velocity model.

20. The medium of claim 12, comprising:
determining drill path planning using the final velocity model.
